(19) United States
(12) Patent Application Publication
(10) Pub. No.: US 2010/0113767 A1
(43) Pub. Date: May 6, 2010

(54) PREPARATION OF SILICON PHTHALOCYANINES AND GERMANIUM PHTHALOCYANINES AND RELATED SUBSTANCES

(75) Inventors: Thomas Gessner, Heidelberg (DE); Ruediger Sens, Ludwigshafen (DE); Wolfgang Ahlers, Nossegem (BE); Christos Vamvakaris, Mannheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/593,097

(22) PCT Filed: Mar. 31, 2008
(86) PCT No.: PCT/EP2008/053779

§ 371 Date: Sep. 25, 2009

(30) Foreign Application Priority Data
Apr. 5, 2007 (EP) 07105776.4

(51) Int. Cl. C09B 47/04

(52) U.S. Cl. 540/128

(57) ABSTRACT

A process for preparing compounds of the general formula (I) by reacting the compound of the general formula (II) where L, L′ are the same or different and are each independently Cl or OH in the presence of a. chlorine compounds Cl-M²R¹R²R³, Cl-M³R⁴R⁵R⁶, with the proviso that L and L′ are not both simultaneously OH, or b. hydroxyl compounds HO-M²R¹R²R³, HO-M³R⁴R⁵R⁶. The use of compounds of the general formula (I) as markers for liquids and a process for detecting markers in liquids.

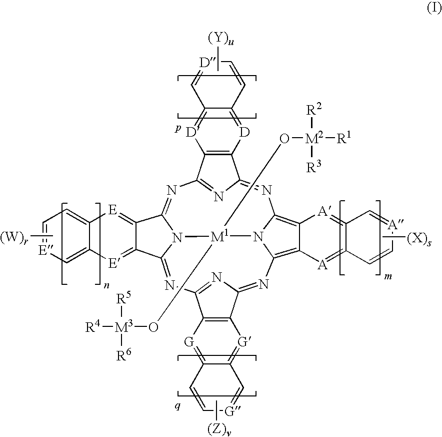

The present invention relates to a process for preparing compounds of the general formula (I)

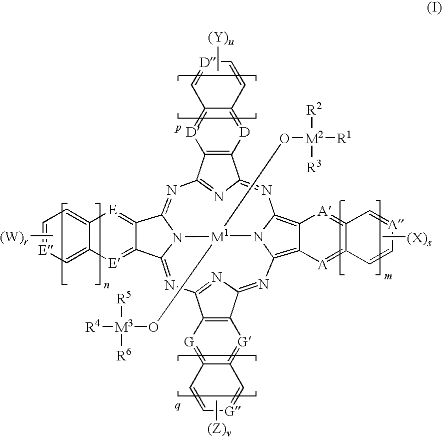

where the symbols and indices are each defined as follows:
M¹, M², M³ are the same or different and are each independently Si or Ge,
A, A′, A″ are the same or different and are each independently CH or N,
D, D′, D″ are the same or different and are each independently CH or N,
E, E′, E″ are the same or different and are each independently CH or N,
G, G′, G″ are the same or different and are each independently CH or N,
n, m, p, q are the same or different and are each independently integers selected from the range from 0 to 2,
r is an integer selected from the range from 1 to (4+n·2),
s is an integer selected from the range from 1 to (4+m·2),
u is an integer selected from the range from 1 to (4+p·2),
v is an integer selected from the range from 1 to (4+q·2),
W, X, Y, Z are the same or different and are each independently halogen, nitro, hydroxyl, cyano, amino, C₁-C₂₀-alkyl, C₂-C₂₀-alkenyl, C₂-C₂₀-alkynyl, C₃-C₁₅-cycloalkyl, aryl, heterocycles, C₁-C₂₀-alkoxy, aryloxy, C₁-C₄-dialkylamino, C₃-C₆-cycloalkylamino, CO₂M, SO₃M, C₁-C₄-dialkylsulfamoyl,
R¹ to R⁶ are the same or different and are each independently C₁-C₂₀-alkyl-, C₂-C₂₀-alkenyl-, C₂-C₂₀-alkynyl-, C₃-C₁₅-cycloalkyl-, aryl-, arylalkyl-, C₁-C₂₀-alkoxy-, C₁-C₂₀-alkylthio-, aryloxy-, trialkylsiloxy-, CO₂M, SO₃M, C₁-C₄-trialkylammonium-substituted C₁-C₂₀-alkyl radicals,
M is hydrogen, alkali metal,
where the substituents R¹ to R⁶, W, X, Y or Z may each be interrupted at any position by one or more heteroatoms, where the number of these heteroatoms is not more than 10, preferably not more than 8, even more preferably not more than 5 and especially not more than 3, and/or may be substituted in each case at any position, but not more than five times, preferably not more than four times and more preferably not more than three times, by C₁-C₂₀-alkyl, C₁-C₂₀-alkoxy, aryl, aryloxy, heterocycles, heteroatoms, NR₂ (where R=hydrogen, C₁-C₂₀-alkyl), SO₃M, CO₂M or halogen, where these may likewise be substituted not more than twice, preferably not more than once, by the groups mentioned.

The invention further relates to particular compounds of the general formula (I) and to the use of particular compounds of the general formula (I) as markers for liquids. The invention comprises liquids which comprise particular compounds of the general formula (I) as markers. The invention further relates to processes for detecting markers in liquids and for identifying liquids which comprise at least one compound of the general formula (I). Further embodiments of the present invention can be taken from the claims, the description and the examples. It is self-evident that the features of the inventive subject matter which have been specified above and which are yet to be explained below can be used not only in the combination stated specifically in each case but also in other combinations without leaving the scope of the invention. Preference and particular preference is given especially also to those embodiments of the present invention in which all features of the inventive subject matter have the preferred and very preferred definitions.

Other processes for preparing particular compounds which fall under the general formula (I), especially phthalocyanine and naphthalocyanine derivatives, are known. In general, these other known processes comprise the preparation or provision of the corresponding isoindolines which are then, if appropriate in the presence of metal compounds, converted to the corresponding metal-free or metal-containing phthalo- or naphthalocyanines. It is also known for particular other processes that the metal compounds may be silicon chlorides, which, after incorporation into, for example, a phthalocyanine compound, can be hydrolyzed to the corresponding dihydroxides. Other processes for the conversion of the dihydroxides to siloxy compounds with the aid of chlorosilanes are likewise known. Details of these other prior art processes are explained below:

U.S. Pat. No. 3,509,146 describes the preparation of metal-free phthalocyanines and related compounds from 1,3-diiminoisoindolines or their heterocyclic analogs in conjunction with alkylalkanolamines.

EP 0 373 643 A2 describes the preparation of metal-containing phthalocyanines from mixtures of o-phthalodinitriles and/or 1,3-diiminoisoindolines by reaction with metallic compounds. This reaction can, in accordance with EP 0 373 643 A2, take place either in the presence of 1,8-diazabicyclo[5.4.0]-7-undecene (DBU) in alcohols or alternatively in high-boiling solvents such as chloronaphthalene, bromonaphthalene or trichlorobenzene. The metal-containing phthalocyanines of EP 0 373 643 A2 find use as absorbers in the near infrared for optical recording media.

U.S. Pat. No. 3,094,536 describes the preparation of dichloro- and dihydroxysilicon phthalocyanines. The dichlorosilicon phthalocyanines are prepared from phthalodinitriles and silicon chlorides in a quinoline solution.

B. L. Wheeler et al., J. Am. Chem. Soc. 1984, 106, 7404-7410 (see also N. Sasa et al., J. Mol. Structure 446 (1998) 163-178) describe the synthesis of bis(tri-n-hexylsiloxy)(2,3-phthalocyaninato)silicon (silicon phthalocyanine bis(trihexylsilyl oxide)) and its naphthalocyanine analog from the dihydroxides of the compounds with the aid of tri-n-hexylchlorosilane.

U.S. Pat. No. 5,872,248 describes the preparation of silicon phthalocyanines and naphthalocyanines by reacting the metal-free compounds with trichlorosilane.

DE 38 10 956 A1 describes silicon naphthalocyanine derivatives which may bear different siloxy substituents and their preparation with the aid of various chlorosilanes.

EP 0 499 345 A2 describes the synthesis of dihydroxysilicon naphthalocyanine and bis(triethylsiloxy)silicon naphthalocyanine on the basis of the dichloro compound. Dichlorosilicon naphthalocyanine (silicon naphthalocyanine dichloride) is in turn prepared from diiminobenzo(f)-isoindoline with silicon tetrachloride.

Also known are various phthalocyanine and naphthalocyanine derivates as markers for liquids:

The documents DE 42 24 301 A1 and DE 197 21 399 A1 describe phthalocyanine and naphthalocyanine derivates and their use as markers for liquids.

DE 42 43 774 A1 describes processes for detecting markers including phthalocyanine derivatives in liquids and an instrument for executing the process.

An increased long-term stability of aryl- or alkoxy-substituted phthalocyanines which are used as markers in mineral oils compared to typical mineral oil additives is known from our unpublished EP document with the application reference 06111161.3.

The use of various silicon phthalocyanine and silicon naphthalocyanine derivatives for marking mineral oils is known from U.S. Pat. No. 5,525,516. An apparatus and a method for identifying the marked mineral oils by detecting fluorescence radiation in the near infrared are likewise described in U.S. Pat. No. 5,525,516.

In practice, it is found that many of the known preparation processes afford a comparatively low yield of end products which can be used as markers. A further problem with many markers, especially in mineral oils with the additives typically present therein, or in additive concentrates, is that they often do not have the desired long-term stability. As a result of the action of said additives, for example, the spectral properties (e.g. absorbance) of the markers change. Frequently, exact detection of the markers and reliable identification of liquids, especially at low marker concentrations, is only possible to a limited degree after prolonged periods.

It was therefore an object of the invention to find efficient preparation processes for markers. It was a further object of the invention to provide markers which feature good long-term stability (=storage stability) in the liquids to be marked, especially mineral oils and additive concentrates.

These and other objects are, as is evident from the disclosure content of the present invention, achieved by the various embodiments of the process according to the invention, which are described below.

Accordingly, a process has been found for preparing the compounds of the general formula (I) described at the outset, wherein the compound of the general formula (II)

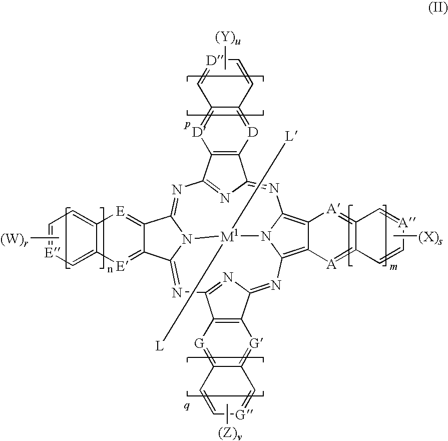

where
L, L′ are the same or different and are each independently Cl or OH, in the presence of
   a. chlorine compounds Cl-M²R¹R²R³, Cl-M³R⁴R⁵R⁶, with the proviso that L and L′ are not both simultaneously OH, or
   b. hydroxyl compounds HO-M²R¹R²R³, HO-M³R⁴R⁵R⁶
      are reacted, where the symbols and indices are each as defined at the outset for the compounds of the general formula (I).

It has also been found that the above-described compounds of the general formula (I) have a very good long-term stability, especially toward customary fuel additives.

In the context of this invention, expressions of the form Cₐ-C_{b} denote chemical compounds or substituents having a particular number of carbon atoms. The number of carbon atoms can be selected from the entire range from a to b, including a and b; a is at least 1 and b is always greater than a. A further specification of the chemical compounds or of the substituents is effected by expressions of the form Cₐ-C_{b}—V. In this case, V represents a chemical compound class or substituent class, for example alkyl compounds or alkyl substituents.

Halogen represents fluorine, chlorine, bromine or iodine, preferably fluorine, chlorine or bromine, more preferably fluorine or chlorine.

Specifically, the collective terms specified for the different substituents R¹ to R⁶, W, X, Y, Z and M are each defined as follows:

C₁-C₂₀-Alkyl: straight-chain or branched hydrocarbon radicals having up to 20 carbon atoms, for example C₁-C₁₀-alkyl or C₁₁-C₂₀-alkyl, preferably C₁-C₁₀-alkyl, for example C₁-C₃-alkyl, such as methyl, ethyl, propyl, isopropyl, or C₄-C₆-alkyl, n-butyl, sec-butyl, tert-butyl, 1,1-dimethylethyl, pentyl, 2-methylbutyl, 1,1-dimethylpropyl, 1,2-dimethylpropyl, 2,2-dimethylpropyl, 1-ethylpropyl, hexyl, 2-methylpentyl, 3-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 2-ethylbutyl, 1,1,2-trimethylpropyl, 1,2,2-trimethylpropyl, 1-ethyl-1-methylpropyl, 1-ethyl-2-methylpropyl, or C₇-C₁₀-alkyl such as heptyl, octyl, 2-ethylhexyl, 2,4,4-trimethylpentyl, 1,1,3,3-tetramethylbutyl, nonyl or decyl, and isomers thereof.

C₂-C₂₀-Alkenyl: unsaturated, straight-chain or branched hydrocarbon radicals having from 2 to 20 carbon atoms and a double bond in any position, for example C₂-C₁₀-alkenyl or C₁₁-C₂₀-alkenyl, preferably C₂-C₁₀-alkenyl such as C₂-C₄-alkenyl, such as ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, or C₅-C₆-alkenyl, such as 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl or 1-ethyl-2-methyl-2-propenyl, and also C₇-C₁₀-alkenyl such as the isomers of heptenyl, octenyl, nonenyl or decenyl.

C₂-C₂₀-Alkynyl: straight-chain or branched hydrocarbon groups having from 2 to 20 carbon atoms and a triple bond in any position, for example C₂-C₁₀-alkynyl or C₁₁-C₂₀-alkynyl, preferably C₂-C₁₀-alkynyl such as C₂-C₄-alkynyl, such as ethynyl, 1-propynyl, 2-propynyl, 1-butynyl, 2-butynyl, 3-butynyl, 1-methyl-2-propynyl, or C₅-C₇-alkynyl, such as 1-pentynyl, 2-pentynyl, 3-pentynyl, 4-pentynyl, 1-methyl-2-butynyl, 1-methyl-3-butynyl, 2-methyl-3-butynyl, 3-methyl-1-butynyl, 1,1-dimethyl-2-propynyl, 1-ethyl-2-propynyl, 1-hexynyl, 2-hexynyl, 3-hexynyl, 4-hexynyl, 5-hexynyl, 1-methyl-2-pentynyl, 1-methyl-3-pentynyl, 1-methyl-4-pentynyl, 2-methyl-3-pentynyl, 2-methyl-4-pentynyl, 3-methyl-1-pentynyl, 3-methyl-4-pentynyl, 4-methyl-1-pentynyl, 4-methyl-2-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl or 1-ethyl-1-methyl-2-propynyl, and C₇-C₁₀-alkynyl such as the isomers of heptynyl, octynyl, nonynyl, decynyl.

C₃-C₁₅-Cycloalkyl: monocyclic saturated hydrocarbon groups having from 3 up to 15 carbon ring members, preferably C₃-C₈-cycloalkyl such as cyclopropyl, cyclobutyl, cyclopentyl, cyclohexyl, cycloheptyl or cyclooctyl, and a saturated or unsaturated cyclic system, for example norbornyl or norbenzyl.

Aryl: a mono- to tricyclic aromatic ring system comprising from 6 to 14 carbon ring members, for example phenyl, naphthyl or anthracenyl, preferably a mono- to bicyclic, more preferably a monocyclic, aromatic ring system.

Heterocycles: five- to twelve-membered, preferably five- to nine-membered, more preferably five- to six-membered, ring systems having oxygen, nitrogen and/or sulfur atoms and optionally a plurality of rings, such as furyl, thiophenyl, pyrryl, pyridyl, indolyl, benzoxazolyl, dioxolyl, dioxyl, benzimidazolyl, benzthiazolyl, dimethylpyridyl, methylquinolyl, dimethylpyrryl, methoxyfuryl, dimethoxypyridyl, difluoropyridyl, methylthiophenyl, isopropylthiophenyl or tert-butylthiophenyl. Moreover, especially five- or six-membered saturated nitrogen-containing ring systems which are attached via a ring nitrogen atom and which may also comprise one or two further nitrogen atoms or a further oxygen or sulfur atom.

C₁-C₂₀-Alkoxy is a straight-chain or branched alkyl group having from 1 to 20 carbon atoms (as specified above) which is attached via an oxygen atom (—O—), for example C₁-C₁₀-alkoxy or C₁₁-C₂₀-alkoxy, preferably C₁-C₁₀-alkyloxy, especially preferably C₁-C₃-alkoxy, for example methoxy, ethoxy, propoxy.

Aryloxy is a mono- to tricyclic aromatic ring system (as specified above) which is attached via an oxygen atom (—O—), preferably a mono- to bicyclic, more preferably a monocyclic, aromatic ring system.

Arylalkyl is a mono- to tricyclic aromatic ring system (as specified above) which is attached via a C₁-C₂₀-alkylene group, preferably a mono- to bicyclic, more preferably a monocyclic, aromatic ring system.

C₁-C₂₀-alkylene: straight-chain or branched hydrocarbon radicals having from 1 to 20 carbon atoms, for example C₁-C₁₀-alkylene or C₁₁-C₂₀-alkylene, preferably C₂-C₁₀-alkylene, especially methylene, dimethylene, trimethylene, tetramethylene, pentamethylene or hexamethylene.

Heteroatoms are preferably oxygen, nitrogen or sulfur.

C₁-C₄-dialkylamino is an amino group substituted by two identical or different straight-chain or branched alkyl groups having from 1 to 4 carbon atoms (as specified above), for example C₁-C₂-dialkylamino or C₃-C₄-dialkylamino, preferably C₁-C₂-dialkylamino, which is attached via the nitrogen.

C₃-C₆-cycloalkylamine is an amino group substituted by a C₃-C₆-cycloalkyl group having from 3 to 6 carbon atoms (as specified above), for example C₃-C₄-cycloalkylamine or C₅-C₆-cycloalkylamine, preferably C₅-C₆-cycloalkylamine, which is attached via the nitrogen.

C₁-C₄-dialkylsulfamoyl is an amino group of a sulfonamide substituted by two identical or different straight-chain or branched alkyl groups having from 1 to 4 carbon atoms.

C₁-C₄-trialkylammonium is an ammonium group substituted by three identical or different straight-chain or branched alkyl groups having from 1 to 4 carbon atoms (as specified above), for example C₁-C₂-trialkylammonium or C₃-C₄-trialkylammonium, preferably C₁-C₂-trialkylammonium, which is attached via the nitrogen.

In the process according to the invention, as already described above, compounds of the general formula (I) are prepared by reacting compounds of the general formula (II) in the presence of the chlorine compounds Cl-M²R¹R²R³ and Cl-M³R⁴R⁵R⁶ or hydroxyl compounds HO-M²R¹R²R³ and HO-M³R⁴R⁵R⁶. For example, the substituents L and L′ of the compounds of the general formula (II) are both Cl, or L=CL and L′=OH. The chlorine compounds Cl-M²R¹R²R³ and Cl-M³R⁴R⁵R⁶ are referred to hereinafter together as “Cl compounds”. Analogously, the hydroxyl compounds HO-M²R¹R²R³ and HO-M³R⁴R⁵R⁶ are referred to hereinafter together as “HO compounds”. In the process according to the invention, preference is given to using the Cl compounds. The Cl compounds and HO compounds are common knowledge and in many cases commercially available, or can be prepared by processes well known to those skilled in the art.

To react compounds of the general formula (II) in the presence of the Cl compounds or HO compounds, an excess of Cl compounds or HO compounds is generally used. The molar ratio of Cl compounds or HO compounds to compounds of the general formula (II) is preferably 10:1, more preferably 3:1 and, for example, even 2:1.

The compounds of the general formulae (I) and (II) comprise, of course, as well as the 2,3 compounds, for example the 2,3-naphthalocyanines or 2,3-anthracyanines, also the isomeric 1,2 compounds.

The compounds of the general formulae (I) and (II) may be present or may be prepared in the process according to the invention as acid addition salts of the particular compound.

Of course, it is also possible with the aid of the process according to the invention to obtain mixtures of compounds of the general formula (I) by reacting mixtures of compounds of the general formula (II) in the presence of the Cl compounds or HO compounds.

It is likewise possible in the process according to the invention to use mixtures of different Cl-M²R¹R²R³ and Cl-M³R⁴R⁵R⁶ as Cl compounds or mixtures of different HO-M²R¹R²R³ and HO-M³R⁴R⁵R⁶ as HO compounds. Preference is given to using those mixtures in which M² and M³ are the same. More preferably, M²=M³=Si. The individual compounds Vₓ (where x=1 to the number of different compounds) in the mixtures differ by different substituents R¹, R², R³ and R⁴, R⁵, R⁶. For example, it is possible with preference to use two different compounds Cl-M²R¹R¹R¹ (V₁) and Cl-M²R²R²R² (V₂) or HO-M²R¹R¹R¹ (V₁) and HO-M²R²R²R² (V₂) as mixtures. It is likewise possible with preference to use mixtures of three different compounds Cl-M²R¹R¹R¹ (V₁), Cl-M²R²R²R² (V₂), and Cl-M²R³R³R³ (V₃) or HO-M²R¹R¹R¹ (V₁), HO-M²R²R²R² (V₂) and HO-M²R³R³R³ (V₃). Of course, it is also possible to use any mixtures, for example Cl-M²R¹R²R³ (V₁), Cl-M²R⁴R⁴R⁶ (V₂), Cl-M³R¹R²R² (V₃), and Cl-M²R⁴R⁵R⁶ (V₄), in which case the symbols M², M³ and R¹ to R⁶ are all selected differently from one another.

The quantitative ratios of the different compounds of the mixtures which can be used in the process according to the invention are generally as desired. The molar ratio in the case of a mixture of two different compounds V₁:V₂ is preferably from 10:1 to 1:10; the ratio is more preferably from 3:1 to 1:3 and especially 1:1. In the case of a mixture of three different compounds, the molar ratio is preferably V₁:V₂:V₃=1: from 1 to 3: from 1 to 3, to V₁:V₂:V₃=3: from 1 to 3: from 1 to 3; the V₁:V₂:V₃ ratio is more preferably 1:1:1.

In the process according to the invention, the total amount of the chlorine compounds Cl-M²R¹R²R³ and Cl-M³R⁴R⁵R⁶ or hydroxyl compounds HO-M²R¹R²R³ and HO-M³R⁴R⁵R⁶ can be added in one or more steps.

In the process according to the invention, preference is given to preparing compounds of the general formula (I) in which the indices n, m, p and q are equal to 0 or all equal to 1. Very preferably, the indices n, m, p and q all assume the value of 0. In a further preferred embodiment, the indices n, m, p and q all assume the value of 1.

In the process according to the invention, preference is likewise given to preparing compounds of the general formula (I) in which the symbols A, A′, A″, D, D′, D″, E, E′, E″ and G, G′, G″ are all CH.

In the process according to the invention, particular preference is given to preparing compounds of the general formula (I) in which the indices n, m, p and q are all equal to 0 or all equal to 1, and the symbols A, A′, A″, D, D′, D″, E, E′, E″ and G, G′, G″ are all CH. Especially preferably in this case, the indices n, m, p and q are all equal to 0.

In addition, in the process according to the invention, particular preference is given to preparing compounds of the general formula (I) in which the symbols M¹, M² and M³ are all Si.

In addition, in the process according to the invention, particular preference is given to preparing compounds of the general formula (I) in which the symbols R¹ to R⁶ are C₁-C₂₀-alkyl, aryl, or arylalkyl. Most preferably, the symbols R¹ to R⁶ are C₁-C₂₀-alkyl, in particular C₁-C₁₀-alkyl and especially C₄-C₆-alkyl.

In the process according to the invention, preference and great preference is given to preparing especially compounds of the general formula (I) in which substantially all symbols and indices have the preferred and very preferred definitions.

Preference is given to preparing the compounds of the general formula (I) in the presence of a solvent. In principle, suitable solvents are all substances which are liquid at the temperatures of the process according to the invention and in which the substances involved in the reaction in the process according to the invention are at least partly soluble. For example, these solvents have boiling points of over 100° C. at standard pressure (101.325 kPa). The solutions of the compounds of the general formula (I) used in the process according to the invention in the presence of a solvent may also have the properties of suspensions or dispersions. Suitable solvents are, for example, aromatic compounds or dipolar aprotic compounds. Preference is given to using aromatic compounds as solvents. Particularly preferred solvents are toluene, xylene, mesitylene, tetralin, chlorobenzene, dichlorobenzene, quinoline, pyridine or sulfolane. Very particular preference is given to chlorobenzene or pyridine. It is of course also possible to use mixtures of solvents. The amount of solvents which can be used in the process according to the invention is dependent upon the solubility of the compounds dissolved and can therefore vary within a wide range. Preference is given to adding the solvent in excess (weight ratio). Very preferably, the weight ratio of the compounds of the general formula (II): solvent is from 1:2 to 1:20.

The temperatures which are established for the preparation of the general compounds of the formula (I) in the process according to the invention may in principle vary within a wide range. In general, the selection of the temperature range will, for example, as described above, depend on the solubility of the compounds of the general formulae (I) and (II), and can be determined by the person skilled in the art by simple preliminary experiments. In the case of a relatively high solubility, it is possible, for example, to select relatively low temperatures for the reaction in the process according to the invention. The temperatures in the process according to the invention are generally selected from the range from 0° C. to 200° C. The temperatures are preferably in the range from 20° C. to 150° C. Very particular preference is given to selecting temperatures from the range from 70° C. to 140° C.

The pressure range within which the process according to the invention for preparing compounds of the general formula (I) is performed is variable. The process according to the invention can be performed at standard pressure, slightly reduced pressure or else elevated pressure. For example, the pressure is selected from the range from 90 kPa to 1000 kPa. Preference is given to a pressure from the range from 100 kPa to 500 kPa.

Preference is given to effecting the inventive reaction of the compounds of the general formula (II) in the presence of the chlorine compounds Cl-M²R¹R²R³ and Cl-M³R⁴R⁵R⁶ or hydroxyl compounds HO-M²R¹R²R³ and HO-M³R⁴R⁵R⁶ to compounds of the general formula (I) additionally in the presence of a base or of a base/water mixture. In principle, this embodiment of the process according to the invention can be performed with any bases. For example, it is possible to use NaOH (as a solid or aqueous solution), alkali metal carbonate (alkali metal=Na, K), alkali metal hydrogencarbonate, and mixtures of these bases. Preference is given to using NaOH (as a solid or aqueous solution) or potassium carbonate. A very preferred base is NaOH (powder). The amount of base used is guided by the amount of hydrogen chloride (HCl) released. Preference is given to using an excess of base, based on HCl released, of from 0 to 100%.

In another embodiment of the process according to the invention, the reaction of the compounds of the general formula (II) in the presence of the chlorine compounds Cl-M²R¹R²R³ and Cl-M³R⁴R⁵R⁶ or hydroxyl compounds HO-M²R¹R²R³ and HO-M³R⁴R⁵R⁶ to give compounds of the general formula (I) is performed additionally in the presence of a phase transfer catalyst. For example, the substituents L and L′ of the compounds of the general formula (II) are both Cl, both are OH, or L=Cl and L′=OH. In principle, any phase transfer catalysts are suitable for this purpose. Phase transfer catalysts (PTCs) and their preparation are common knowledge to those skilled in the art (ROMPP Online, “Phasentransferkatalyse” [Phase transfer catalysis], Georg Thieme Verlag, document identifier RD-16-01507; M. J. Dagani, et al., “Bromine Compounds”, Ullmann's Encyclopedia of Industrial Chemistry, Wiley-VCH, 2002). Many PTCs can be purchased commercially. For example, the PTCs used may be tetraalkylammonium salts, phosphonium salts, onium compounds, crown ethers or polyethylene glycols. Preferred PTCs are hexaethylguanidinium salts, especially hexaethylguanidinium chloride, 4-dimethylamino-N-(2-ethylhexyl)pyridinium salts, especially 4-dimethylamino-N-(2-ethylhexyl)pyridinium chloride, tetraalkylphosphonium salts, tetraarylphosphonium salts, tris[2-(2-methoxyethoxy)ethyl]amine or tetraalkylammonium salts. In addition, the PTC used may preferably be Aliquat®HTA-1 from Cognis. Aliquat®HTA-1 is a water-soluble quaternary ammonium salt and is used, for example, in an aqueous solution comprising: from 30 to 36% by weight of Aliquat®HTA-1, from 50 to 62% by weight of water and from 10 to 15% by weight of NaCl. Particular preference is given to using, in the process according to the invention, especially at high reaction temperatures (>100° C.), hexaethylguanidinium chloride, 4-dimethylamino-N-(2-ethylhexyl)-pyridinium chloride, tetraalkylphosphonium salts, tetraarylphosphonium salts, tris[2-(2-methoxy-ethoxy)ethyl]amine. Hexaethylguanidinium chloride is very preferred. The amount of PTC which is used in the process according to the invention can vary within a wide range. Preference is given to using from 0.01 to 10 mol % of PTC based on compounds of the general formula (II).

In a preferred embodiment of the process according to the invention, the preparation of compounds of the general formula (I) comprises the following steps:
a) initial charging in a solvent:
   a. of the compounds of the general formula (II),
   b. of the chlorine compounds Cl-M²R¹R²R³ and Cl-M³R⁴R⁵R⁶ or hydroxyl compounds HO-M²R¹R²R³ and HO-M³R⁴R⁵R⁶,
   c. of a base,
   d. of a PTC.
b) optionally heating the mixture from step 1,
c) optionally one or more additions:
   a. of the chlorine compounds Cl-M²R¹R²R³ and Cl-M³R⁴R⁵R⁶ or hydroxyl compounds HO-M²R¹R²R³ and HO-M³R⁴R⁵R⁶,
   b. optionally of a base,
d) optionally cooling,
e) removal of the compounds of the general formula (I),
f) workup of the compounds of the general formula (I).

The steps 1.a. to 1.d. of the process according to the invention can be performed in any sequence. For example, the compounds of the general formula (I.a.) can be added before the other steps (1.b. to 1.d., in any sequence). However, it is also possible in another embodiment to initially charge first the chlorine compounds Cl-M²R¹R²R³ and Cl-M³R⁴R⁵R⁶ or hydroxyl compounds HO-M²R¹R²R³ and HO-M³R⁴R⁵R⁶ (1.b.) in a solvent and then to perform steps 1.a., 1.c., and 1.d. in any sequence.

The duration of all time steps 1. to 6. overall, and of the individual steps, is generally of minor significance. The duration of all time steps together may vary within a wide range from a few minutes up to 24 h. A longer duration would be conceivable but of little interest owing to the disadvantageous space-time yield.

The process can be performed in any apparatus which is suitable for this purpose and is well known to those skilled in the art. For the removal and workup of the compounds of the general formula (I), it is possible to use any methods with which the person skilled in the art is familiar. For example, the removal is effected by filtration or phase separation. The workup may comprise a purification step, for example washing of the compounds of the general formula (I) with a liquid, for example methanol, and/or a drying step.

The compounds of the general formula (II) converted in the process already described above for preparing compounds of the general formula (I) may be prepared by a process according to the invention, where the symbols and indices are each as defined at the outset in formula (I).

The process according to the invention for preparing the compounds of the general formula (II) is effected by reacting compounds of the general formula (III a) to (III d)

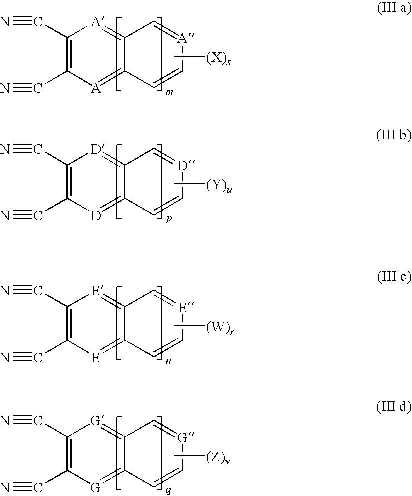

without isolating the isoindoline derivatives (III a') to (III d') (or tautomers thereof) of the compounds (III a) to (III d). Isolation is understood here to mean the recovery of the isoindoline derivates as pure substances.

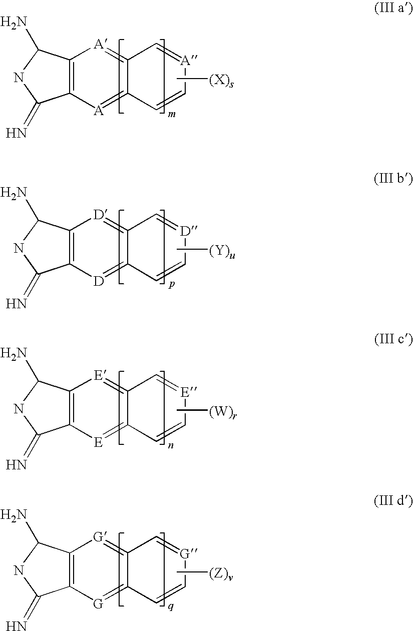

In one embodiment of the process according to the invention, the compounds of the general formula (II) are prepared by reacting compounds of the general formula (III a) to (III d), comprising the following steps (a)-(d):
(a) dissolving compounds of the general formula (III a) to (III d) in a solvent,
(b) reacting the dissolved compounds from (a) in the presence of ammonia and strong bases,
(c) exchanging the solvent from (a) for another solvent without removing and/or working up compounds formed in step (b),
(d) reacting the dissolved compounds from (c) with M¹Cl₄.

In principle, suitable solvents in step (a) and (b) of the process according to the invention for preparing the compounds of the general formula (II) are all substances which are liquid at the temperatures of this process according to the invention in step (a) and (b) and in which the substances involved in the reaction are at least partly soluble. The solutions used in the process according to the invention may also have the properties of suspensions or dispersions. It will be appreciated that it is also possible to use mixtures of solvents. Suitable solvents in step (a) and (b) are, for example, alcohols. Preferred solvents are methanol, ethanol, n-propanol, i-propanol, n-butanol or i-butanol. Very preferably, methanol is used.

In general, it is possible in step (b) to use any strong bases or mixtures thereof. Preferred strong bases have, for example, a pK_{B} of 9 or greater. Especially preferred strong bases are alkoxides or amines; sodium methoxide is very preferred.

The other solvent in step (c) of the process according to the invention for preparing the general compounds of the formula (II) is selected generally depending on the solubility of the compounds of the general formula (II) and the temperatures required for the reaction in step (d). For example, the other solvent has a higher boiling point than the solvent from step (a); the other solvent is preferably a high-boiling solvent (boiling point>100° C.). The other solvents used in step (c) are preferably solvents having a boiling point greater than the temperatures required for the reaction in step (d). It will be appreciated that it is also possible to use mixtures of solvents or mixtures of high-boiling solvents with a base. For example, the high-boiling solvents used can be quinoline or a mixture of tetralin and tributylamine (the amount of tributylamine is guided by the amount of HCl released in step (d)). Preference is given to using quinoline.

Preference is given to using, as the compound M¹Cl₄ in step (d), silicon tetrachloride (M¹=Si).

The exchange of the solvent from (a) for another solvent while avoiding removal and/or workup steps of the compounds formed in step (b), in step (c) of the above-described process, enables a high yield in the overall process. The solvent can be exchanged in any manner, for example continuously or else batchwise. For example, the exchange may comprise two steps, firstly the removal of the solvent from (a) and secondly the addition of the other solvent from (c). The solvent from (a) can be removed before or after the addition of the other solvent from (c). However, the solvent from (a) can also be removed simultaneously with the addition of the other solvent from (c). Preference is given to removing the solvent from (a) by distillation and adding the other solvent from (c) by metered addition into the reaction vessel.

The temperatures which are set for the preparation of the general compounds of the formula (II) in the process according to the invention, especially in step (b) and step (d), can in principle vary within a wide range. In general, the selection of the temperature range in step (b) and step (d), for example as mentioned above, will depend on the solubility of the compounds of the general formulae (IIIa-IIId) and (II). The temperature in step (b) generally also depends on the reactivity of the reactants. The temperatures required can be determined by those skilled in the art by simple preliminary experiments. In the case of a relatively high solubility, it is possible, for example, to select relatively low temperatures for the reaction in step (b) and (d) of the process according to the invention. The temperatures in the process according to the invention are generally selected from the range from 20° C. to 250° C. The temperatures in step (b) are preferably in the range from 20° C. to 150° C. Most preferably, for step (b), temperatures are selected from the range from 40° C. to 120° C., especially from 50° C. to 100° C. The temperatures in step (d) are preferably in the range from 100° C. to 250° C. Very preferably, for step (d), temperatures are selected from the range from 120° C. to 230° C., especially from 140° C. to 220° C.

The pressure range within which the process according to the invention for preparing compounds of the general formula (II) is performed is variable. The process according to the invention can be performed at standard pressure, slightly reduced pressure or else under elevated pressure. For example, the pressure is selected from the range from 90 kPa to 1000 kPa. Preference is given to a pressure from the range from 100 kPa to 500 kPa.

If the tetrachlorides M¹Cl₄ are volatile, preference is given to performing the reaction in step (d) of the above-described process with slow attainment of the reaction temperature and/or under elevated pressure.

The duration of all time steps (a) to (d) overall, and also of the individual steps, is generally of minor significance and depends on the temperature. The duration of all time steps together may vary within a wide range from a few minutes up to 48 h. A longer duration would be conceivable but of little interest owing to the disadvantageous space-time yield.

Before further processing of the compounds of the general formula (II), they can be removed and worked up by methods known to those skilled in the art by, for example, filtration, washing of the solid, phase separation or drying.

In the process according to the invention, preference is given to preparing compounds of the general formula (II) in which the indices n, m, p and q are all equal to 0 or all equal to 1. Very preferably, the indices n, m, p and q all assume the value of 0.

In the process according to the invention, preference is likewise given to preparing compounds of the general formula (II) in which the symbols A, A′, A″, D, D′, D″, E, E′, E″ and G, G′, G″ are all CH.

In the process according to the invention, particular preference is given to preparing compounds of the general formula (II) in which the indices n, m, p and q are all equal to 0 or equal to 1, and the symbols A, A′, A″, D, D′, D″, E, E′, E″ and G, G′, G″ are all CH. Especially preferably in this case, the indices n, m, p and q are all equal to 0.

The compounds of the general formula (II) prepared by the process according to the invention can serve to prepare compounds of the general formula (I).

As already mentioned above, the present invention also relates to the use of compounds of the general formula (I) as markers for liquids (inventive use), where the symbols and indices are each defined as specified at the outset for the formula (I):
(A) and if A, A′, A″, D, D′, D″, E, E′, E″, G, G′, G″ are all CH and
   n, m, p, q are all equal to 0 or 1 and
   the liquid is an oil or mineral oil and
   M¹ is Si,
   not all substituents R¹ to R³ are simultaneously, and not all substituents R⁴ to R⁶ are simultaneously, C₁-C₂₀-alkyl, C₁-C₂₀-alkoxy, or aryloxy;
(B) and if A, A′, A″, D, D′, D″, E, E′, E″, G, G′, G″ are all CH and
   n, m, p, q are all equal to 1 and
   M¹ to M³ are each Si,
   R¹ to R⁶ are the same or different and are each independently C₂-C₂₀-alkynyl-, C₃-C₁₅-cycloalkyl-, aryl-, aryloxy-, trialkylsiloxy-, or C₁-C₄-trialkylammonium-substituted C₁-C₂₀-alkyl radicals.

In the above-described inventive use, the symbols and indices, in addition to the statements made above, are preferably defined as
n, m, p, q are each equal to 0,
W, X, Y, Z are the same or different and are each independently C₁-C₂₀-alkyl, C₁-C₂₀-alkoxy, aryloxy, C₃-C₆-cycloalkylamino, five- or six-membered saturated nitrogen-containing ring systems which are attached via a ring nitrogen atom and which may also comprise one or two further nitrogen atoms or one further oxygen or sulfur atom,
R¹ to R⁶ are the same or different and are each independently C₁-C₂₀-alkyl, aryl, C₁-C₂₀-alkoxy, aryloxy,
and
if A, A′, A″, D, D′, D″, E, E′, E″, G, G′, G″ are all CH and the liquid is an oil or mineral oil and
M¹ is Si,
not all substituents R¹ to R³ are simultaneously, and not all substituents R⁴ to R⁶ are simultaneously, C₁-C₂₀-alkyl, C₁-C₂₀-alkoxy, or aryloxy.

Moreover, in the case of the above-described inventive use, the symbols and indices, in addition to the statements made above, are preferably defined as
n, m, p, q are each equal to 1,
W, X, Y, Z are the same or different and are each independently C₁-C₂₀-alkyl, C₁-C₂₀-alkoxy, aryloxy, C₃-C₆-cycloalkylamino, five- or six-membered saturated nitrogen-containing ring systems which are attached via a ring nitrogen atom and which may also comprise one or two further nitrogen atoms or one further oxygen or sulfur atom,
R¹ to R⁶ are the same or different and are each independently C₁-C₂₀-alkyl, aryl, C₁-C₂₀-alkoxy, aryloxy,
and
if A, A′, A″, D, D′, D″, E, E′, E″, G, G′, G″ are all CH and
the liquid is an oil or a mineral oil and
M¹ is Si,
not all substituents R′ to R³ are simultaneously, and not all substituents R⁴ to R⁶ are simultaneously, C₁-C₂₀-alkyl, C₁-C₂₀-alkoxy, or aryloxy,
and
if A, A′, A″, D, D′, D″, E, E′, E″, G, G′, G″ are all CH and
M¹ to M³ are each Si,
R¹ to R⁶ are the same or different and are each independently aryl or aryloxy.

The inventive use as markers can also be performed with mixtures of the compounds of the general formula (I), with the proviso of the restrictions specified above.

Some of the compounds of the general formula (I) are known and some are novel.

The invention therefore also provides compounds of the general formula (I) in which the symbols and indices are each defined as follows:

### R¹═R²═R³═R⁴═R⁵═R⁶ and

all other symbols and indices are each as defined initially. Also novel are therefore mixtures of compounds of the general formula (I) which comprise these novel compounds. Preference is further given to the compounds of the formula (Ia).

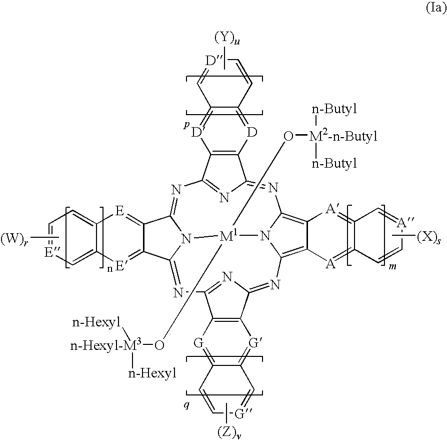

Further preferred novel compounds are compounds of the general formula (I) in which the symbols and indices are each defined as follows:

### R¹═R²═R⁴═R⁵=Me, R³═R⁶═CH₂(C₁₃H₂₇)₂ or

R¹═R²═R⁴═R⁵=Me, i-Pr (isopropyl), R³═R⁶═OC₈H₁₇ and
all other symbols and indices are each as defined initially.

More preferably, in the novel compounds, M¹=M²=M³=Si.

Suitable liquids which can be marked in accordance with the process according to the invention by means of the compounds of the general formula (I) are in particular water or organic liquids, for example alcohols such as methanol, ethanol, propanol, isopropanol, butanol, isobutanol, sec-butanol, pentanol, isopentanol, neopentanol or hexanol, glycols such as 1,2-ethylene glycol, 1,2- or 1,3-propylene glycol, 1,2-, 2,3- or 1,4-butylene glycol, di- or triethylene glycol or di- or tripropylene glycol, ethers such as methyl tert-butyl ether, 1,2-ethylene glycol monomethyl or dimethyl ether, 1,2-ethylene glycol monoethyl or diethyl ether, 3-methoxypropanol, 3-isopropoxypropanol, tetrahydrofuran or dioxane, ketones, such as acetone, methyl ethyl ketone or diacetone alcohol, esters such as methyl acetate, ethyl acetate, propyl acetate or butyl acetate, aliphatic or aromatic hydrocarbons such as pentane, hexane, heptane, octane, isooctane, petroleum ether, toluene, xylene, ethylbenzene, tetralin, decalin, dimethylnaphthalene, petroleum spirit, brake fluids or oils such as mineral oils which, in accordance with the invention, comprise gasoline, kerosene, diesel oil and heating oil, natural oils such as olive oil, soybean oil or sunflower oil, or natural or synthetic motor, hydraulic or trans-mission oils, for example vehicle motor oil or sewing machine oil.

Particularly advantageously, the compounds of the general formula (I) are used in accordance with the process according to the invention for the marking of oils, especially mineral oils, preferably additive concentrates.

The invention further provides liquids, preferably oils, especially mineral oils, which comprise at least one compound of the general formula (I) as a marker.

The compounds of the general formula (I) to be used as markers are added to the liquids in such amounts that reliable detection is ensured. Typically, the (weight-based) total content of markers in the marked liquid is from about 0.1 to 5000 ppb, preferably from 1 to 2000 ppb and more preferably from 1 to 1000 ppb.

To mark the liquids, the compounds are added generally in the form of solutions (stock solutions). Especially in the case of mineral oils, suitable solvents for preparing these stock solutions are preferably aromatic hydrocarbons such as toluene, xylene or relatively high-boiling aromatic mixtures.

In order to avoid an excessively high viscosity of such inventive stock solutions (and hence poor metering and handling), a total concentration of the markers of from 0.5 to 50% by weight, based on the total weight of these stock solutions, is generally selected.

The compounds of the general formula (I) may, if appropriate, also be used in mixtures with other markers/dyes. In that case, the total amount of the markers in the liquids is typically within the above-described range.

The invention also provides a process for marking liquids, preferably oils, especially mineral oils, preferably additive concentrates, wherein a compound of the general formula (I) is added to the liquid.

The invention also provides a method for detecting markers in liquids which comprise at least one compound of the general formula (I).

The compounds of the general formula (I) in the liquids are detected by common methods. Since these compounds generally have a high absorption capacity and/or exhibit fluorescence, one example of a possibility in the given case is spectroscopic detection.

The compounds of the general formula (I) generally have their absorption maximum in the range from 600 to 1000 nm and/or fluoresce in the range from 600 to 1200 nm and can thus be detected easily with suitable instruments.

The detection can be carried out in a manner known per se, for example by measuring the absorption spectrum of the liquids to be analyzed.

However, it is also possible to excite the fluorescence of the compounds of the general formula (I) present in the liquids, advantageously with a semiconductor laser or a semiconductor diode. It is particularly advantageous to employ a semiconductor laser or a semiconductor diode with a wavelength in the spectral range from λₘₐₓ−100 nm to λₘₐₓ+20 nm. λₘₐₓ means the wavelength of the longest-wavelength absorption maximum of the marker. The wavelength of maximum emission is generally in the range from 620 to 900 nm.

The fluorescence light thus generated is advantageously detected with a semiconductor detector, especially with a silicon photodiode or a germanium photodiode.

The detection succeeds particularly advantageously when an interference filter and/or an edge filter (with a short-wavelength transmission edge in the range from λₘₐₓ to λₘₐₓ+80 nm) and/or a polarizer is disposed upstream of the detector.

By means of the abovementioned compounds, it is possible in a very simple manner to detect marked liquids even when the compounds of the general formula (I) are present only in a concentration of about 1 ppm (detection by absorption) or about 5 ppb (detection by fluorescence).

A preferred method for detecting markers in liquids which comprise at least one compound of the general formula (I) in an amount which is sufficient to excite detectable fluorescence on irradiation with radiation of a suitable wavelength is performed by:
a) irradiating the liquid with electromagnetic radiation of a wavelength of from 600 to 1000 nm and
b) detecting the fluorescence radiation induced with a device for detecting radiation in the range from 600 to 1200 nm.

A further preferred process for detecting markers in liquids which comprise at least one compound of the general formula (I) in an amount which is sufficient to exhibit detectable absorption on irradiation with radiation of a suitable wavelength is performed by:
a) irradiating the liquid with electromagnetic radiation of a wavelength of from 600 to 1000 nm and
b) detecting the absorption of the radiation a) with a device for detecting radiation in the range from 600 to 1000 nm.

The invention also provides a method for identifying liquids, preferably oils, especially mineral oils, preferably additive concentrates, which comprise a compound of the general formula (I) in an amount which is sufficient to excite detectable fluorescence on irradiation with a suitable wavelength, wherein
a) the liquid is irradiated with electromagnetic radiation of a wavelength of from 600 to 1000 nm and
b) the absorption of the electromagnetic radiation a) is detected with a device for detecting radiation and
c) the fluorescence radiation induced is detected with a device for detecting radiation in the range from 600 to 1200 nm and
d) the liquid is identified with the aid of the absorption b) and/or fluorescence c) and
e) the concentration of the compound of the general formula (I) in the liquid is determined with the aid of fluorescence radiation c).

In a preferred embodiment of the method according to the invention for identification, the measurement data from steps b) and e) of the process are combined in order to perform the identification. The identification may comprise, as a further step, comparison with known spectroscopic data. For example, the known spectroscopic data are electronically stored spectra which may be deposited, for example, in databases.

The compounds of the general formula (I) may also be used as a component in additive concentrates (also referred to hereinafter, following the relevant terminology, as “packages”), which, as well as a carrier oil and a mixture of different fuel additives, generally also comprise dyes and, for the invisible fiscal or manufacturer-specific marking, additionally markers. These packages enable various mineral oil distributors to be supplied from a “pool” of unadditized mineral oil, and only with the aid of their individual packages are the company-specific additization, color and marking imparted to the mineral oil, for example during the filling into appropriate transport vessels.

Packages are known, for example, from WO 2005/063942. Reference is made explicitly to this document (WO 2005/063942) and its contents are hereby incorporated into this application.

The components present in such inventive packages are then in particular:
a) at least one compound of the general formula (I),
b) at least one carrier oil,
c) at least one additive selected from the group consisting of
   i. detergents,
   ii. dispersants and
   iii. valve seat wear-inhibiting additives,
d) and also, if appropriate, further additives and assistants.

For a more precise definition of the components b) to d) listed individually, reference is made here explicitly to the disclosure of the abovementioned prior art document (WO 2005/063942) (page 13 line 29-page 20 line 26).

The concentration of component a), i.e. of the at least one compound of the general formula (I), in the inventive packages is typically selected in such a magnitude that, after addition of the package to the mineral oil, the desired concentration of marker(s) is present therein. Typical concentrations of the markers in the mineral oil are, for instance, in the range from 0.01 up to a few 10 s of ppm by weight.

Component b), i.e. the at least one carrier oil, is present in the packages typically in a concentration of from 1 to 50% by weight, in particular from 5 to 30% by weight, and component c), i.e. the at least one detergent and/or the at least one dispersant, typically in a concentration of from 25 to 90% by weight, in particular from 30 to 80% by weight, based in each case on the total amount of components a) to c) and, if appropriate, d), the sum of the individual concentrations of components a) to c) and, if appropriate, d) adding up to 100% by weight.

When, as component d), corrosion inhibitors, antioxidants or stabilizers, demulsifiers, antistats, metallocenes, lubricity improvers and amines to reduce the pH of the fuel are present in the packages, the sum of their concentrations typically does not exceed 10% by weight, based on the total weight of the package (i.e. the total amount of components a) to c) and d)), the concentration of the corrosion inhibitors and demulsifiers being typically in the range of from in each case about 0.01 to 0.5% by weight of the total amount of the package.

When, as component d), additional organic solvents (i.e. not already introduced with the remaining components) are present in the packages, the sum of their concentrations typically does not exceed 20% by weight, based on the total amount of the package. These solvents generally stem from solutions of the markers and/or dyes, which are added to the packages instead of the pure markers and/or dyes with a view to more precise meterability.

When, as component d), further markers other than the compounds of the general formula (I) are present in the packages, their concentration is in turn based on the content that they are to have after addition of the packages in mineral oil. That which was stated for component a) applies mutatis mutandis.

When, as component d), dyes are present in the inventive packages, their concentration is typically, for instance, between 0.1 to 5% by weight, based on the total amount of the package.

The present invention provides efficient preparation processes for markers. In addition, markers which feature good long-term stability in the liquids to be marked, especially oils, mineral oils or additive concentrates, have been found.

The invention is illustrated in detail by the examples without the examples restricting the subject matter of the invention.

### Abbreviations:

nm: nanometers.
UV/Vis (toluene): UV/Vis spectrum in the wavelength range from 300 nm to 900 nm of the substance dissolved in toluene.
λₘₐₓ: wavelength of longest-wavelength absorption maximum in nm.
Mass extinction ME: derives from the molar decadic extinction coefficient by dividing it by the molecular weight of the particular compound, with the unit l/(g*cm)=1000 cm²/g.
λₑₘ: wavelength of shortest-wavelength emission maximum in nm.
Room temperature: 20° C.

### EXAMPLE 1

### Preparation of Silicon Phthalocyanine Dichloride

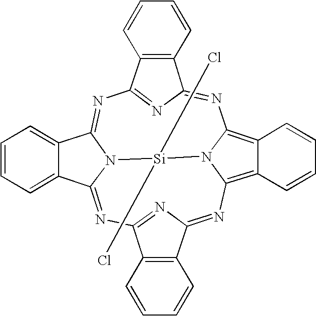

### a) Comparative Experiment—from 1-amino-3-iminoisoindoline

169.9 g (106.8 ml; 0.930 mol) of silicon tetrachloride were added dropwise at from 40 to 50° C. within 45 min with cooling to a solution of 100.0 g (0.689 mol) of 1-amino-3-iminoisoindoline in 657 ml of 97% by weight quinoline. The reaction mixture was heated to 215° C. within 4 h and kept at from 215 to 219° C. for 2 h. After cooling to 120° C., 325 ml of toluene were added slowly and, after further cooling to 70° C., 325 ml of methanol, in the course of which further cooling was effected. After the suspension had been cooled to from 40 to 50° C., the solid was filtered off with suction. The residue was washed with methanol and acetone and then dried at 50° C. under reduced pressure. 90.2 g (86% of theory) of analytically pure dark violet microcrystals having an m.p. of >390° C. were obtained. The preparation was effected according to the method of Y. Kojima, Y. T. Osano and T. Ohashi, Bull. Chem. Soc. Jpn., 72, 2203-2210 (1999).

### b) Inventive Process—from o-phthalodinitrile

3.32 g (0.0185 mol) of 30% by weight sodium methoxide solution were metered at room temperature under nitrogen and with stirring within 15 min into a suspension of 80.08 g (0.628 mol) of o-phthalodinitrile in 250 ml of anhydrous methanol. Ammonia was introduced into the suspension for 15 min (20 g/h). Thereafter, the suspension was heated to boiling with ammonia introduction under reflux for one hour. With stirring, 598 ml of 97% by weight quinoline were added. Methanol was dissolved off up to a bath temperature of 60° C. Subsequently, the reaction mixture was inertized with nitrogen and cooled to room temperature. 143.9 g (0.847 mol) of tetrachlorosilane were added dropwise at from 25 to 47° C. within one hour. The reaction mixture was heated to 215° C. and stirred at from 215 to 221° C. for two hours. After the reaction mixture had been cooled to 120° C., 296 ml of toluene were added dropwise, in the course of which a solid precipitated out and the temperature fell to 75° C. At from 65 to 75° C., 296 ml of methanol were added dropwise. The reaction mixture was stirred at 50° C. for 15 min and then filtered. The residue was washed with methanol and acetone and dried at 60° C. under reduced pressure. 84.1 g (88% of theory) of black-blue microcrystals were obtained.

A reaction at from 180 to 181° C. instead of from 215 to 221° C. for 16 h gave rise to a yield of 82.7 g (86% of theory).

### EXAMPLE 2

### Comparative Experiment—preparation of silicon phthalocyanine bis(tri-n-hexylsilyl oxide)

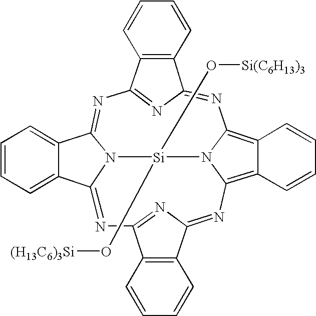

2.24 g (3.9 mmol) of silicon phthalocyanine dihydroxide and 13.06 g (39.7 mmol) of 97% by weight chlorotri-n-hexylsilane were heated to boiling (115° C.) under reflux in 225 ml of anhydrous pyridine for 5 hours. After cooling to room temperature, the reaction solution was filtered, which left a blue residue (0.093 g). The filtrate was substantially concentrated and then admixed with pentane. The precipitate was filtered off with suction, washed with pentane, acetone and water, and dried at 50° C. under reduced pressure. The crude product (4.04 g) was dissolved in 50 ml of heptane/toluene (2:1). Undissolved fractions were removed and dried at 50° C. under reduced pressure. 1.15 g of violet powder having a melting point of 171-174° C. (lit. 175-177° C.) were obtained. The filtrate was purified on aluminum oxide neutral type 510 (activation level 1) with heptane/toluene (2:1) as the eluent. 1.58 g of violet powder were obtained, which had a material-of-value content of 80 mol % (determined by UV/Vis). The total yield of material of value was 53% of theory. The preparation was effected according to the method of B. L. Wheeler et al., J. Am. Chem. Soc. 1984, 106, 7404-7410.

### EXAMPLE 3

### Inventive preparation of silicon phthalocyanine bis(tri-n-hexylsilyl oxide) with PTC

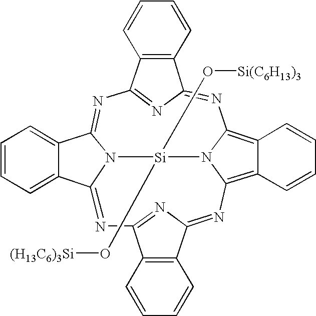

a) 2.87 g (4.7 mmol) of silicon phthalocyanine dichloride, 4.93 g (15.0 mmol) of chlorotri-n-hexylsilane, 1.00 g (25.0 mmol) of sodium hydroxide (powder) and 0.04 g of Aliquat® HTA-1 (Cognis) were heated to boiling (132° C.) under reflux in 25 ml of chlorobenzene. After one hour, another 1.64 g (5.0 mmol) of chlorotri-n-hexylsilane were added and, after a further hour, another 1.64 g (5.0 mmol) of chlorotri-n-hexylsilane and 0.40 g (10 mmol) of sodium hydroxide (powder). After heating at reflux temperature for a further 4 hours, the solution was allowed to cool to room temperature. The solution was filtered, which left a residue. The filtrate was concentrated to dryness and then admixed with methanol. The solid was filtered off with suction, washed with methanol and water and dried at 50° C. under reduced pressure. 5.05 g of blue powder were obtained, which comprised 99 mol % of material of value (UV/Vis). The calculated material of value yield was 93% of theory.

UV/Vis (toluene): λₘₐₓ=668 nm, mass extinction ME=335.1 l/(g*cm), λₑₘ=671 nm.

b) 2.87 g (4.7 mmol) of silicon phthalocyanine dichloride, 4.93 g (15.0 mmol) of chlorotri-n-hexylsilane, 1.00 g (25.0 mmol) of sodium hydroxide (powder) and 0.12 g of Aliquat® HTA-1 (Cognis) were heated to boiling (117° C.) under reflux in 25 ml of pyridine. After one hour, 1.64 g (5.0 mmol) of chlorotri-n-hexylsilane were added and, after a further hour, another 1.64 g (5.0 mmol) of chlorotri-n-hexylsilane and 0.40 g (10 mmol) of sodium hydroxide (powder). After heating at reflux temperature for 3.5 hours, the solution was allowed to cool to room temperature. The solution was filtered, which left a small residue. The filtrate was concentrated to dryness and then admixed with methanol. The suspension was filtered off with suction. The residue was washed with methanol and water and dried at 50° C. under reduced pressure. 5.59 g of blue powder were obtained, which comprised 81 mol % of material of value (UV/Vis).

The calculated material of value yield was 85% of theory. UV/Vis (toluene): λₘₐₓ=668 nm, mass extinction ME=274.2 l/(g*cm), λₑₘ=671 nm.

### EXAMPLE 4

### Preparation of silicon phthalocyanine bis(tri-n-butylsilyl oxide)

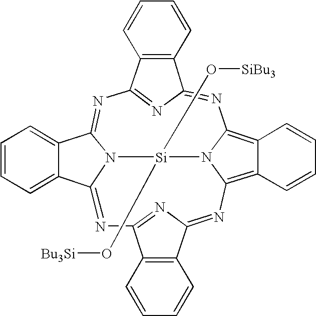

A solution of 3.63 g (15.0 mmol) of 97% by weight tri-n-butylchlorosilane, 0.94 g (23.5 mmol) of sodium hydroxide (powder) and 0.04 g of Aliquat® HTA-1 (Cognis) in 25 ml of chlorobenzene was stirred at room temperature for 3 hours and then admixed with 2.87 g (4.7 mmol) of silicon phthalocyanine dichloride and 1.63 g (11.8 mmol) of potassium carbonate. The reaction mixture was heated to boiling (132° C.) under reflux for a total of six hours, in the course of which 1.21 g (5.0 mmol) of 97% by weight tri-n-butylchlorosilane in each case were added after one and two hours. After the solution had been cooled to room temperature, the solution was filtered. The filtrate was concentrated to dryness. The residue was stirred with 10 ml of methanol, filtered with suction, washed with methanol and water, and dried at 50° C. under reduced pressure. 3.78 g of blue powder were obtained, which, compared to a pure substance, comprised 95 mol % of material of value according to UV/Vis. The material of value yield was 79% of theory.

UV/Vis (toluene): λₘₐₓ=668 nm, mass extinction ME=380.6 l/(g*cm), λₑₘ=671 nm.

### EXAMPLE 5

### Preparation of a mixture of silicon phthalocyanine bis(tri-n-hexylsilyl oxide), silicon phthalocyanine tri-n-butylsilyl oxide tri-n-hexylsilyl oxide and silicon phthalocyanine bis(tri-n-butylsilyl oxide)

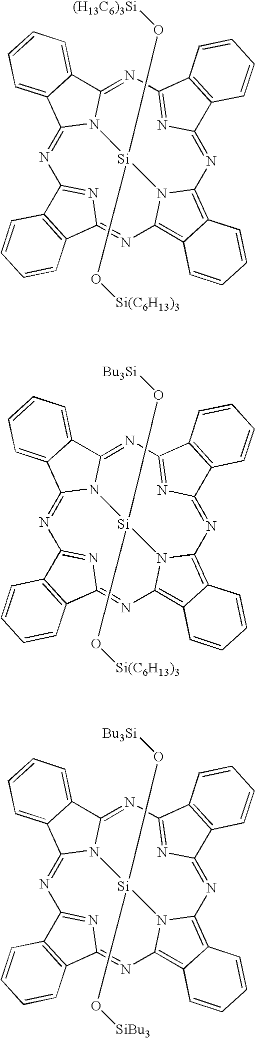

2.47 g (7.5 mmol) of 97% by weight tri-n-hexylchlorosilane and 1.82 g (7.5 mmol) of 97% by weight tri-n-butylchlorosilane were added at room temperature to a solution/suspension of 1.00 g (25.0 mmol) of sodium hydroxide (powder), 2.87 g (4.70 mmol) of silicon phthalocyanine dichloride and 0.0124 g of 20% by weight Aliquat® HTA-1, which had been prepared by diluting one part of Aliquat® HTA-1 (Cognis) with four parts of water, in 25 ml of chlorobenzene. The reaction mixture was heated to boiling and stirred under reflux for one hour. Another 0.82 g (2.5 mmol) of tri-n-hexylchlorosilane and 0.61 g (2.5 mmol) of tri-n-butylchlorosilane were added and the mixture was heated under reflux for one hour. After adding 0.82 g (2.5 mmol) of tri-n-hexylchlorosilane, 0.61 g (2.5 mmol) of tri-n-butylchlorosilane and 0.40 g (10 mmol) of sodium hydroxide (powder), the reaction mixture was stirred under reflux for another four hours. After the solution had been cooled to room temperature, the solution was filtered. The filtrate was concentrated to dryness. The residue was stirred with 20 ml of cold methanol, filtered off with suction, washed with cold methanol and water and dried at 50° C. under reduced pressure. 4.01 g of blue powder were obtained, which, according to the thin-layer chromatogram, comprised three dye components.

UV/Vis (toluene): λₘₐₓ=668 nm, mass extinction ME=357.6 l/(g*cm), λₑₘ=671 nm.

### EXAMPLE 6

### Preparation of silicon Phthalocyanine tri-n-butylsilyl oxide tri-n-hexylsilyl oxide

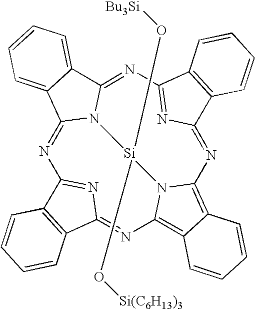

5.0 g of a mixture prepared as in example 5 were dissolved in 500 ml of methylene chloride. After clarifying by filtration, the filtrate was admixed with 20 g of silica gel (60 Å, 70-200 μm) and concentrated to dryness. The residue was purified on silica gel by means of two VersaPak columns connected in series (40×150 mm silica cartridge) with a 4:1 mixture of n-heptane and methylene chloride as the eluent (pump flow rate 300 ml/h). The fractions, which were pure according to thin-layer chromatography, were combined and concentrated to dryness. 0.16 g of blue solid was obtained, which melted at 164° C.

UV/Vis (toluene): λₘₐₓ=668 nm, mass extinction ME=368.05 l/(g*cm), λₑₘ=371 nm.

### EXAMPLE 7

### Preparation of Silicon Phthalocyanine Bis(Triphenylsilyl Oxide)

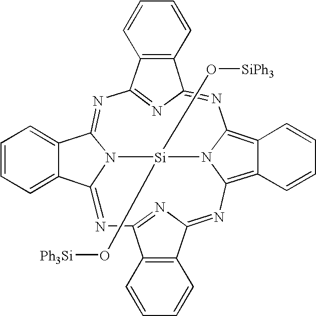

A solution of 7.14 g (23.5 mmol) of 97% by weight triphenylchlorosilane, 0.94 g (23.5 mmol) of sodium hydroxide (powder) and 0.04 g of Aliquat® HTA-1 (Cognis) in 25 ml of chlorobenzene was stirred at room temperature for 3 hours and subsequently admixed with 2.87 g (4.7 mmol) of silicon phthalocyanine dichloride and 1.62 g (11.8 mmol) of potassium carbonate. The reaction mixture was heated to boiling (132° C.) under reflux for six hours. After cooling to room temperature, the reaction mixture was filtered. The residue was washed twice with 25 ml of xylene each time and then with water, filtered off with suction and dried at 50° C. under reduced pressure. The crude product was stirred in 80 ml of methylene chloride, then filtered off with suction and dried at 50° C. under reduced pressure. 3.78 g of blue powder were obtained.

UV/Vis (N-methyl-2-pyrrolidone): λₘₐₓ=672 nm, mass extinction ME=221.6 l/(g*cm), λₑₘ=676 nm.

### EXAMPLE 8

### Preparation of a mixture of silicon phthalocyanine bis(tri-n-hexylsilyl oxide), silicon phthalocyanine tri-n-hexylsilyl oxide triphenylsilyl oxide and silicon phthalocyanine bis(triphenylsilyl oxide)

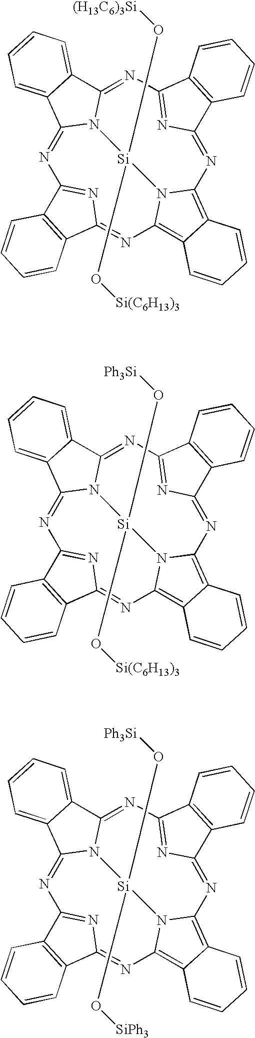

A solution of 3.88 g (11.8 mmol) of 97% by weight tri-n-hexylchlorosilane, 3.59 g (11.8 mmol) of 97% by weight triphenylchlorosilane, 1.39 g (34.8 mmol) of sodium hydroxide (powder) and 0.04 g of Aliquat® HTA-1 (Cognis) in 25 ml of chlorobenzene was stirred at room temperature for one hour and then admixed with 2.87 g (4.7 mmol) of silicon phthalocyanine dichloride. The reaction mixture was heated to boiling (132° C.) under reflux for six hours. After cooling to room temperature, the reaction mixture was filtered. The filtrate was concentrated to dryness and the residue was then stirred with 40 ml of acetonitrile. The solid was filtered off with suction, washed with acetonitrile, methanol and water and dried at 50° C. under reduced pressure. 4.60 g of blue powder were obtained.

UV/Vis (toluene): λₘₐₓ=668 nm, mass extinction ME=210.1 l/(g*cm), λₑₘ=672 nm.

### EXAMPLE 9

### Preparation of silicon phthalocyanine bis(dimethyl-n-octadecylsilyl oxide)

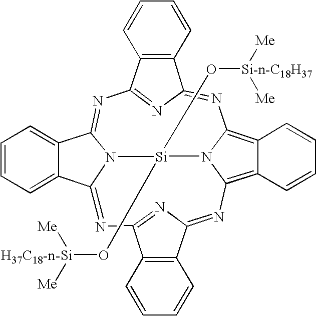

2.87 g (4.7 mmol) of silicon phthalocyanine dichloride, 5.48 g (15.0 mmol) of 95% n-octadecyldimethylchlorosilane, 1.00 g (25.0 mmol) of sodium hydroxide (powder) and 0.04 g of Aliquat® HTA-1 (Cognis) were heated to boiling (132° C.) under reflux in 25 ml of chlorobenzene. After one hour, another 1.83 g (5.0 mmol) of 95% n-octadecyldimethylchlorosilane were added and, after a further hour, another 1.83 g (5.0 mmol) of 95% n-octadecyldimethylchlorosilane and 0.40 g (10 mmol) of sodium hydroxide (powder). After heating at reflux temperature for a further 4 hours, the solution was allowed to cool to room temperature. The solution was filtered, which left a residue. The filtrate was concentrated to dryness and then admixed with methanol. The solid was filtered off with suction, washed with methanol and water and dried at 50° C. under reduced pressure. 7.89 g of blue powder were obtained, of which 2.5 g were dissolved in 500 ml of methylene chloride. After clarifying by filtration, the solution was admixed with 20 g of silica gel and concentrated to dryness. The residue was purified by means of a VersaPak chromatography column (40×150 mm silica cartridge) with a mixture of methylene chloride and n-heptane (mixing ratio from 1:4 through 1:1 to 1:0) as the eluent at a pump flow rate of 300 ml/h. The homogeneous fractions were combined and concentrated to dryness. 0.263 g of blue solid was obtained.

UV/Vis (toluene): λₘₐₓ=668 nm, mass extinction ME=225.8 l/(g*cm), λₑₘ=671 nm.

### EXAMPLE 10

### Preparation of Silicon Phthalocyanine Bis(Dimethyloctadecylsilyl Oxide)

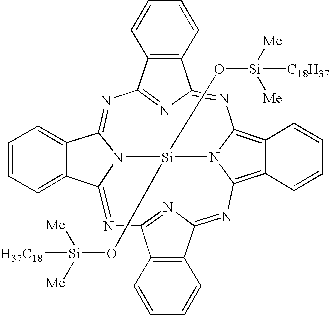

2.87 g (4.7 mmol) of silicon phthalocyanine dichloride, 5.48 g (15.0 mmol) of 97% octadecyldimethylchlorosilane (5-10% C₁₈-isomer mixture), 1.00 g (25.0 mmol) of sodium hydroxide (powder) and 0.04 g of Aliquat® HTA-1 (Cognis) were heated to boiling (132° C.) under reflux in 25 ml of chlorobenzene. After one hour, another 1.79 g (5.0 mmol) of 97% octadecyldimethylchlorosilane (5-10% C₁₈-isomer mixture) were added and, after a further hour, another 1.79 g (5.0 mmol) of 97% octadecyldimethylchlorosilane and 0.40 g (10 mmol) of sodium hydroxide (powder). After heating at reflux temperature for a further 4 hours, the solution was allowed to cool to room temperature. The solution was filtered, which left a residue. The filtrate was concentrated to dryness and then admixed with methanol. The solid was filtered off with suction, washed with methanol and water and dried at 50° C. under reduced pressure. 25.37 g of blue powder were obtained, which was dissolved in 20 ml of heptane-methylene chloride mixture (4:1) and purified on silica gel. The fractions, which were homogeneous according to thin-layer chromatography, were combined and concentrated to dryness. 1.23 g of blue solid were obtained.

UV/Vis (toluene): λₘₐₓ=668 nm, mass extinction ME=221.2 l/(g*cm), λₑₘ=671 nm.

### EXAMPLE 11

### Preparation of Silicon Phthalocyanine Bis(Diisobutyloctadecylsilyl Oxide)

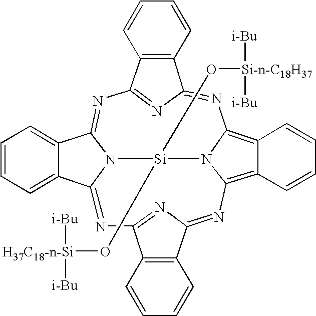

2.87 g (4.7 mmol) of silicon phthalocyanine dichloride, 7.61 g (15.0 mmol) of 97% by weight chlorodiisobutyl-n-octadecylsilane, 1.00 g (25.0 mmol) of sodium hydroxide (powder) and 0.04 g of Aliquat® HTA-1 (Cognis) were heated to boiling (132° C.) under reflux in 25 ml of chlorobenzene. After one hour, another 2.54 g (5.0 mmol) of chlorodiisobutyl-n-octadecylsilane were added and, after a further hour, another 2.54 g (5.0 mmol) of chlorodiisobutyl-n-octadecylsilane and 0.40 g (10 mmol) of sodium hydroxide (powder). After heating at reflux temperature for a further 4 hours, the solution was allowed to cool to room temperature. The solution was filtered, which left a residue. The filtrate was concentrated to an oil. The oil was purified on silica gel (eluent: n-heptane/methylene chloride (4:1)). After the solvent had been removed, 2.01 g of blue solid were obtained.

UV/Vis (toluene): λₘₐₓ=670 nm, mass extinction ME=240.1 l/(g*cm), λₑₘ=672 nm.

### EXAMPLE 12

### Preparation of silicon phthalocyanine bis(dimethyl-13-heptacosylmethylsilyl oxide)

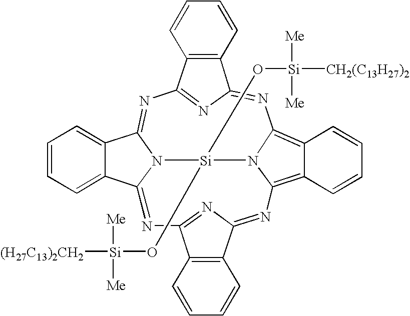

1.44 g (2.4 mmol) of silicon phthalocyanine dichloride, 3.85 g (7.5 mmol) of 95% by weight 13-(chlorodimethylsilylmethyl)heptacosane, 0.50 g (12.5 mmol) of sodium hydroxide (powder) and 0.02 g of Aliquat® HTA-1 (Cognis) were heated to boiling (132° C.) under reflux in 12.5 ml of chlorobenzene. After one hour, another 1.28 g (2.5 mmol) of 13-(chlorodimethylsilylmethyl)heptacosane were added and, after a further hour, another 1.28 g (2.5 mmol) of 13-(chlorodimethylsilylmethyl)heptacosane and 0.20 g (5.0 mmol) of sodium hydroxide (powder). After heating at reflux temperature for a further 4 hours, the solution was allowed to cool to room temperature. The solution was filtered, which left a residue. The filtrate was concentrated to an oil. The oil was purified on silica gel (eluent: n-heptane/methylene chloride (4:1)). After the solvent had been removed, 0.52 g of blue solid was obtained.

UV/Vis (toluene): λₘₐₓ=668 nm, mass extinction ME=257.0 l/g*cm), λₑₘ=671 nm.

### EXAMPLE 13

### Preparation of Silicon Phthalocyanine Bis(Dimethyloctyloxysilyl Oxide)

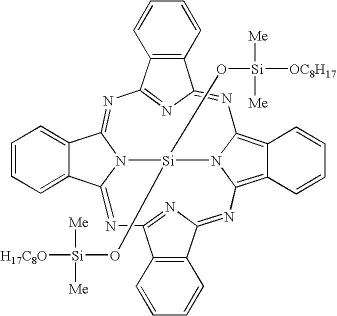

2.70 g (4.7 mmol) of silicon phthalocyanine dihydroxide, 4.17 g (15 mmol) of chlorodimethyloctyloxysilane, which had been prepared analogously to the method in Synth. Commun. 31, 2379-2389, 2001, 3.46 g (25.0 mmol) of potassium carbonate and 0.04 g of Aliquat® HTA-1 (Cognis) were heated to boiling (132° C.) under reflux in 25 ml of chlorobenzene. After one hour, another 1.39 g (5.0 mmol) of chlorodimethyloctyloxysilane were added and, after a further hour, another 1.39 g (5.0 mmol) of chlorodimethyloctyloxysilane and 1.38 g (10.0 mmol) of potassium carbonate. After heating at reflux temperature for a further 4 hours, the solution was allowed to cool to room temperature. The solution was filtered through kieselguhr, which left a residue. The solid was washed with xylene, methanol and water and dried at 50° C. under reduced pressure. 2.22 g of blue solid were obtained.

UV/Vis (toluene): λₘₐₓ=668 nm, mass extinction ME=212.2 l/(g*cm), λₑₘ=674 nm.

### EXAMPLE 14

### Preparation of Silicon Phthalocyanine Bis(Diisopropyloctyloxysilyl Oxide)

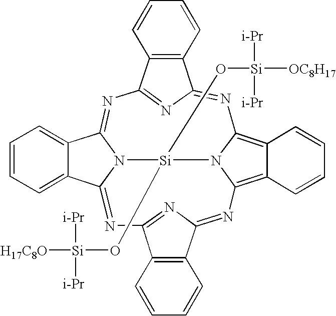

2.70 g (4.7 mmol) of silicon phthalocyanine dihydroxide, 4.17 g (15 mmol) of chlorodiisopropyloctyloxysilane, which had been prepared according to the method in U.S. Pat. No. 5,576,453, 6.50 g (47.0 mmol) of potassium carbonate and 0.04 g of Aliquat® HTA-1 (Cognis) were heated to boiling (132° C.) under reflux in 25 ml of chlorobenzene for six hours. After cooling to room temperature, the solution was filtered, which left a residue. The residue was washed five times with 20 ml of xylene each time. The combined filtrates were concentrated, and the residue was stirred with 50 ml of methanol. The solid was filtered off with suction, washed with methanol and water and dried at 50° C. under reduced pressure. 2.36 g of blue solid were obtained.

UV/Vis (toluene): λₘₐₓ=672 nm, mass extinction ME=329.2 l/(g*cm), λₑₘ=676 nm.

### EXAMPLE 15

### Silicon 1(4),8(11),15(18),22(25)-tetra(3-methylpiperidino)phthalocyanine bis(tri-n-butylsilyl oxide)

### a) 1-amino-3-imino-4-(3-methylpiperidino)isoindoline

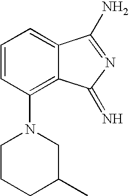

A total of 52 g (3.1 mol) of ammonia were injected into a solution of 90.12 g (0.400 mol) of 3-(3-methylpiperidino)phthalodinitrile and 33.15 g (0.184 mol) of 30% methanolic sodium methoxide solution in 750 ml of anhydrous methanol initially at room temperature for one hour, then at 58-60° C. for 13 hours. Subsequently, the solution was stirred at room temperature overnight (17 h). After stirring with ice-water cooling for one hour, the reaction mixture was filtered. The filter residue was washed with cold methanol and dried at 50° C. under reduced pressure. 75.31 g of pink powder were obtained, which melted at 104° C. The mother liquor was concentrated to dryness and then admixed with 100 ml of methanol. After stirring with ice-water cooling for one hour, the suspension was filtered. The residue was washed with ice-cold methanol and dried at 50° C. under reduced pressure. 12.41 g of pink powder were obtained, which melted at 104° C. The two fractions were combined: 87.72 g (90% of theory).

### b) Silicon 1(4),8(11),15(18),22(25)-tetra(3-methylpiperidino)phthalocyanine dihydroxide

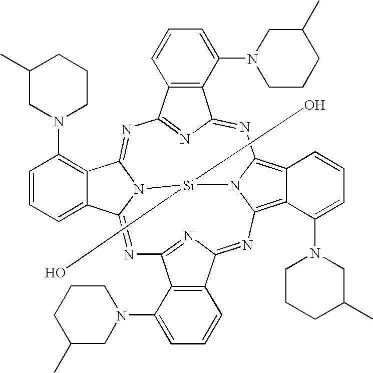

A solution of 12.12 g (50.0 mmol) of 1-amino-3-imino-4-(3-methylpiperidino)isoindoline in 82 ml of anhydrous quinoline was admixed at room temperature with 12.16 g (71.6 mmol) of silicon tetrachloride (exothermic) and heated to 160° C. within one hour. The reaction mixture was kept at this temperature for one hour. After cooling to room temperature, 75 ml of toluene and 100 ml of water were added to the reaction mixture. The addition of 12.6 g of sodium carbonate adjusted the solution to pH 9. Toluene and quinoline were removed by means of steam distillation. After cooling to room temperature, the solution was filtered. The filter residue was washed with water and dried at 50° C. under reduced pressure. 14.01 g of crude product were obtained, which was heated to boiling under reflux in 250 ml of toluene for 30 min. The solution was hot-filtered. The filtrate was concentrated to dryness. 7.45 g of solid were obtained, which were absorbed onto 41 g of silica gel and purified by means of a VersaPak chromatography column (40×150 mm silica cartridge) with toluene/methanol (15:1) as the eluent at a pump flow rate of 2.5 ml/min. The suitable fractions were combined and concentrated to dryness. 1.03 g of black powder were obtained.

UV/Vis (toluene): λₘₐₓ=776 nm, mass extinction ME=103.3 l/(g*cm).

### c) Silicon 1(4),8(11),15(18),22(25)-tetra(3-methylpiperidino)phthalocyanine bis(tri-n-butylsilyl oxide)

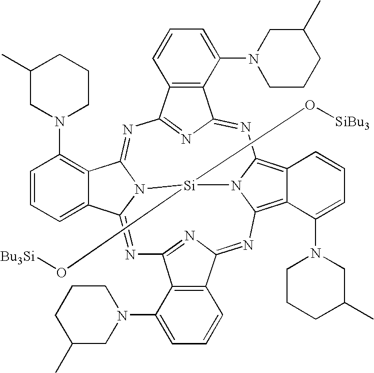

489 mg (0.519 mmol) of tributylchlorosilane were added to a solution of 400 mg of silicon 1(4),8(11),15(18),22(25)-tetra(3-methylpiperidino)phthalocyanine dihydroxide, 1.4 mg (0.0042 mmol) of tetrabutylammonium hydrogensulfate and 575 mg (4.16 mmol) of potassium carbonate in 20 ml of toluene, and the mixture was stirred at room temperature for 6 hours. The solution was filtered, concentrated down to a greasy residue and slurried with a little diethyl ether. The solid was filtered off with suction, washed with diethyl ether and suction-dried under air. 234 mg of black solid were obtained.

UV/Vis (toluene): λₘₐₓ=776 nm, mass extinction ME=35.0 l/(g*cm)

### EXAMPLE 16

### Silicon naphthalocyanine-bis(trihexylsilyl oxide)

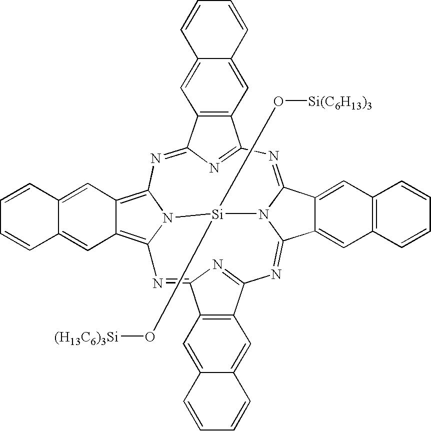

1.00 g (1.23 mmol) of silicon naphthalocyanine dichloride, 1.29 g (3.93 mmol) of 97% tri-n-hexylchlorosilane, 0.26 g (6.6 mmol) of sodium hydroxide (powder) and 0.01 g of Aliquat® HTA-1 (Cognis) were heated to boiling (183° C.) under reflux in 5 ml of 1,2-dichlorobenzene. After one hour, another 0.43 g (1.3 mmol) of 97% tri-n-hexylchlorosilane were added and, after a further hour, another 0.43 g (1.3 mmol) of 97% tri-n-hexylchlorosilane and 0.10 g (2.6 mmol) of sodium hydroxide (powder) were added. After heating at reflux temperature for a further 4 hours, the solution was allowed to cool to room temperature. The solution was filtered, which left a residue, which was subsequently heated in 20 ml of toluene. The solution was hot-filtered and concentrated to dryness. After adding 10 ml of methanol, the solid was filtered off with suction, washed with methanol and dried under reduced pressure. 0.29 g (18% of theory) of olive-green solid was obtained.

UV/Vis (toluene): λₘₐₓ=774 nm, mass extinction ME=397.5 l/(g*cm), λₑₘ=776 nm.

### COMPARATIVE EXAMPLE 17

### 1(4),8(11),15(18),22(25)-tetra(3-methylpiperidino)phthalocyanine

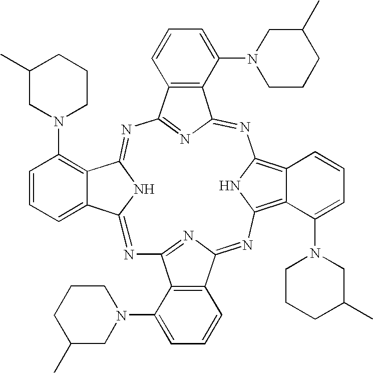

### EXAMPLE 18

### Storage Stability Test in the Presence of Mineral Oil Additives

Approx. 20 mg of the particular substance were dissolved in 25 ml of Solvesso 150 (Shellsol A 150, CAS# 64742-94-5). Any insoluble constituents were removed by filtration. The concentration of the dissolved substance was selected such that the absorbencies of the longest-wavelength absorption bands to be measured were as far as possible between 0.8 and 1.5. 5 ml of the filtrate were made up to 10 ml with a commercial additive based on polyisobutenamine (PIBA) (Kerocom® PIBA 03, commercially produced polyisobutenamine from BASF Aktiengesellschaft), mixed and stored at 40° C. in an ampoule which had been sealed airtight. After the storage times listed in the table below, samples were taken from the ampoules and analyzed in 1 mm cuvettes (UV/VIS). In order to obtain better comparability of the different samples, absorbencies normalized to 1 (absorbance equal to 1 at the start of the storage time) are reported in the table.

| | | Storage | | UV/Vis |
|---|---|---|---|---|
| | | time | Normalized | λₘₐₓ |
| Substance | Additive | [h] | absorbance | [nm] |
| Example 3 | Kerocom ® PIBA 03 | 0 | 1 | 668 |
| | | 600 | 0.95 | 668 |
| Example 4 | Kerocom ® PIBA 03 | 0 | 1 | 668 |
| | | 600 | 0.98 | 668 |
| Example 5 | Kerocom ® PIBA 03 | 0 | 1 | 668 |
| | | 600 | | 668 |
| Example 16 | Kerocom ® PIBA 03 | 0 | 1 | 774 |
| | | 600 | 0.98 | 774 |
| Example 17 | Kerocom ® PIBA 03 | 0 | 1 | 770 |
| (Comparative | | 600 | 0.48 | 770 |
| example) | | | | |

### EXAMPLE 19

### Preparation of a mixture of silicon phthalocyanine bis(tri-n-hexylsilyl oxide), silicon phthalocyanine tri-n-butylsilyl oxide tri-n-hexylsilyl oxide and silicon phthalocyanine bis(tri-n-butylsilyl oxide)

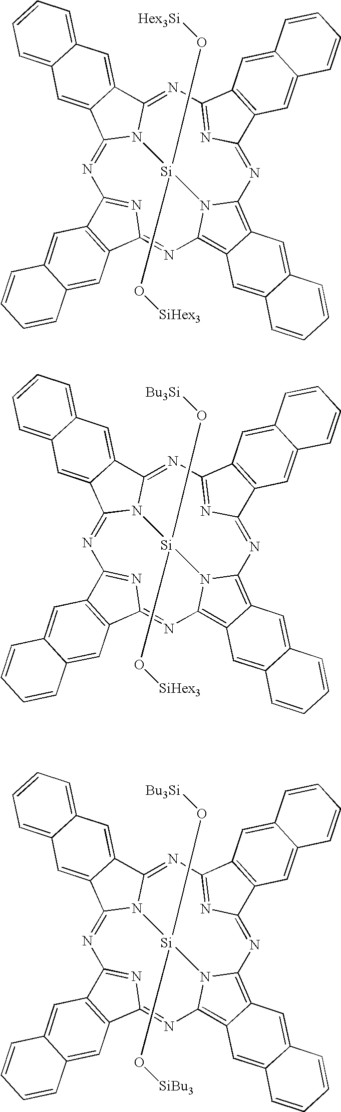

A suspension/solution of 0.25 g (0.323 mmol) 80% silicon 2,3-naphthalocyanine dihydroxide (Aldrich) in 30 ml of 3-picoline and 0.65 g (3.46 mmol) of 99% tributylamine was admixed with 0.54 g (1.65 mmol) of 97% tri-n-hexylchlorosilane and 0.40 g (1.65 mmol) 97% chlorotributylsilane, and heated to boiling under reflux for 1.5 h. After cooling to room temperature, the reaction mixture was filtered, which left no residue.

The filtrate was concentrated on a rotary evaporator and was then admixed with methanol. The solid was filtered off with suction, washed with pentane and dried in a vacuum drying cabinet 0.178 g of green solid was obtained:

UV/Vis (toluene): λₘₐₓ (mass extinction)=774 nm (397.03)

1. A process for preparing a compounds compound of the general formula (I) 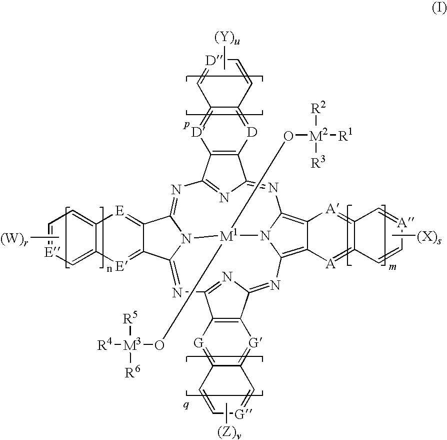
where the symbols and indices are each defined as follows:
M¹, M², M³ are each Si,
A, A′, A″ are each CH,
D, D′, D″ are each CH,
E, E′, E″ are each CH,
G, G′, G″ are each CH,
n, m, p, q are the same or different and are each independently integers range from 0 to 1,
r is an integer from 1 to (4+n·2),
s is an integer from 1 to (4+m√2),
u is an integer from 1 to (4+p·2),
v is an integer from 1 to (4+q·2),
W, X, Y, Z are the same or different and are each independently halogen, nitro, hydroxyl, cyano, amino, C₁-C₂₀-alkyl, C₂-C₂₀-alkenyl, C₂-C₂₀-alkynyl, C₃-C₁₅-cycloalkyl, aryl, heterocycles, C₁-C₂₀-alkoxy, aryloxy, C₁-C₄-dialkylamino, C₃-C₆-cycloalkylamino, CO₂M, SO₃M, dialkylsulfamoyl,
R¹ to R⁶ are the same or different and are each independently C₁-C₂₀-alkyl-, C₂-C₂₀-alkenyl-, C₂-C₂₀-alkynyl-, C₃-C₁₅-cycloalkyl-, aryl-, arylalkyl-, C₁-C₂₀-alkoxy-, C₁-C₂₀-alkylthio-, aryloxy-, trialkylsiloxy-, CO₂M, SO₃M, C₁-C₄-trialkylammonium-substituted C₁-C₂₀-alkyl radicals,
M is hydrogen, alkali metal,
where the substituents R¹ to R⁶, W, X, Y or Z each is optionally interrupted at any position by one or more heteroatoms, where the number of these heteroatoms is not more than 10, and/or is optionally substituted in each case at any position, but not more than five times, by C₁-C₂₀-alkyl, C₁-C₂₀-alkoxy, aryl, aryloxy, heterocycles, heteroatoms, NR₂ (where R=hydrogen, C₁-C₂₀-alkyl), SO₃M, CO₂M or halogen, comprising
reacting a compound of formula (II) 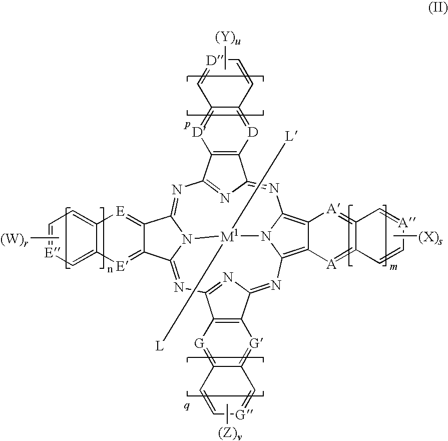
where
L, L′ are the same or different and are each independently Cl or OH, in the presence of
a. chlorine compounds Cl-M²R′R²R³, Cl-M³R⁴R⁵R⁶, with the proviso that L and L′ are not both simultaneously OH, or
b. hydroxyl compounds HO-M²R′R²R³, HO-M³R⁴R⁵R⁶.

2. The process according to claim 1, wherein the indices n, m, p and q are all equal to 0 or are all equal to 1.

3. The process according to claim 1, wherein the reaction is carried out in a solvent.

4. The process according to claim 1, wherein the reaction is carried out in the presence of a base or of a mixture of base with water.

5. The process according to claim 1, wherein the reaction is carried out in the presence of a phase transfer catalyst, where, optionally L and L′ are both simultaneously be OH.

6. A process for preparing general compounds of the formula (II) according to claim 1, where the symbols and indices are each as defined in claim 1, comprising reacting compounds of the general formula (III a) to (III d) 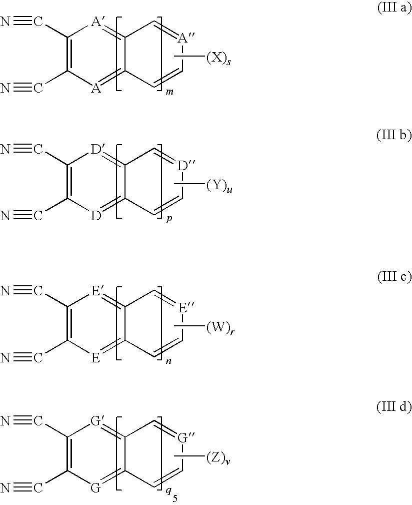
without isolating the isoindoline derivatives of the compounds (III a) to (III d), and further comprising (a)-(d):
(a) dissolving compounds of the general formula (III a) to (III d) in a solvent,
(b) reacting the dissolved compounds from (a) in the presence of ammonia and strong bases,
(c) exchanging the solvent from (a) for another solvent without removing and/or working up compounds formed in (b), and
(d) reacting the dissolved compounds from (c) with M¹Cl₄.

7. The process according to claim 6, wherein the indices n, m, p and q are all equal to 0 or all equal to 1.

8. A marker comprising a compound of the general formula (I) according to claim 1 wherein
(A) if
n, m, p, q are all equal to 0,
not all substituents R¹ to R³ are simultaneously, and not all substituents R⁴ to R⁶ are simultaneously, C₁-C₂₀-alkyl, C₁-C₂₀-alkoxy, or aryloxy, and
(B) if
n, m, p, q are all equal to 1,
R¹ to R⁶ are the same or different and are each independently C₂-C₂₀-alkynyl-, C₃-C₁₅-cycloalkyl-, aryl-, aryloxy-, trialkylsiloxy-, or C₁-C₄-trialkylammonium-substituted C₁-C₂₀-alkyl radicals.

9. The marker according to claim 8, wherein
n, m, p, q are each equal to 0,
W, X, Y, Z are the same or different and are each independently C₁-C₂₀-alkyl, C₁-C₂₀-alkoxy, aryloxy, C₃-C₆-cycloalkylamino, five- or six-membered saturated nitrogen-containing ring systems which are attached via a ring nitrogen atom and which may also optionally comprise one or two further nitrogen atoms or one further oxygen or sulfur atom.

10. The marker according to claim 8, wherein:
n, m, p, q are each equal to 1,
W, X, Y, Z are the same or different and are each independently C₁-C₂₀-alkyl, C₁-C₂₀-alkoxy, aryloxy, C₃-C₆-cycloalkylamino, five- or six-membered saturated nitrogen-containing ring systems which are attached via a ring nitrogen atom and which optionally comprise one or two further nitrogen atoms or one further oxygen or sulfur atom.

11. A compound of the formula Ia′)

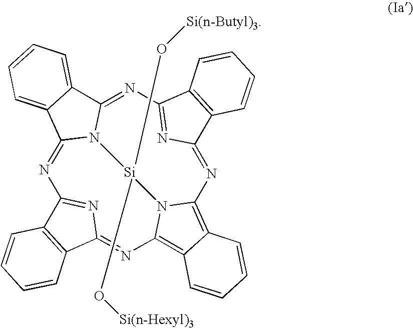

12. A compound of the formula (Ib′)

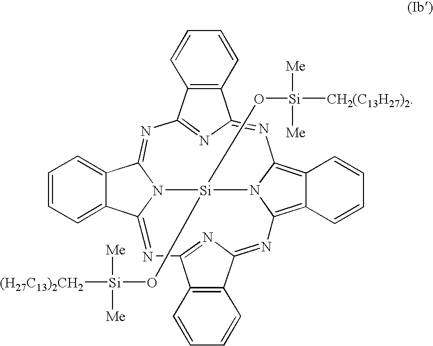

13. A compound of the formula (Ic′), where R¹═R²═R⁴═R⁵=methyl, isopropyl.

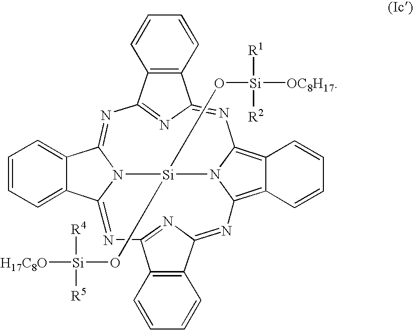

14. A compound of the formula (Id′), where R′═O—Si(n-butyl)₃.

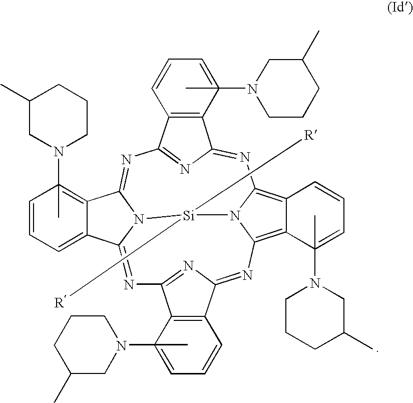

15. The compound of the general formula (I) according to claim 1, where R¹═R²═R³≠R⁴═R⁵═R⁶.

16. A mixture comprising the compound according to claim 15.

17. A marker comprising the compound according to claim 15.
